(19) United States
(12) Patent Application Publication
(10) Pub. No.: US 2015/0169866 A1
(43) Pub. Date: Jun. 18, 2015

(54) OBJECT CONTROL METHOD AND APPARATUS OF ELECTRONIC DEVICE

(71) Applicant: Samsung Electronics Co., Ltd., Gyeonggi-do (KR)

(72) Inventor: Jin YOON, Seoul (KR)

(73) Assignee: Samsung Electronics Co., Ltd.

(21) Appl. No.: 14/572,151

(22) Filed: Dec. 16, 2014

(30) Foreign Application Priority Data
Dec. 16, 2013 (KR) 10-2013-0156448

(51) Int. Cl. G06F 21/45; G06F 21/36; G06F 21/31

(52) U.S. Cl. CPC G06F 21/45; G06F 21/31; G06F 21/36

(57) ABSTRACT

An object control method and apparatus is provided for locking and unlocking an object with an object-specific password. The object control method includes displaying a screen having a plurality of objects, detecting a user gesture for controlling password configuration on the screen, displaying, when one of the plurality of objects is selected, a password input window, and configuring information input through the password input window as the password of the one of the plurality of objects.

### PRIORITY

This application claims priority under 35 U.S.C. §119(a) of a Korean Patent Application filed on Dec. 16, 2013 in the Korean Intellectual Property Office and assigned Serial No. 10-2013-0156448, the entire disclosure of which is incorporated herein by reference.

### BACKGROUND

1. Field of the Invention

The present invention relates generally to an object control method of an electronic device and more particularly, to an object control method of an electronic device for locking and unlocking an object with an object-specific password.

2. Description of Related Art

Recently, electronic devices, such as a smartphone and a tablet PC have become very popular. People's daily lives are enriched with various functions from such electronic devices, functions such as, still and motion picture shooting, music and video file playback, gaming, broadcast playback, and mobile Internet.

Typically, electronic devices are configured to store and manage personal user information and business-related information. For the purpose of securing this information, electronic devices are typically provided with a password-based lock function. However, the conventional lock function is applicable within a restricted range of situations (e.g. at the start point of an application or on a predetermined screen) and lacks the ability to be configured to protect only user-specified objects of the electronic device.

### SUMMARY

The present invention has been made to address at least the problems and disadvantages described above, and to provide at least the advantages described below.

Accordingly, an aspect of the present invention is to provide a method and apparatus for configuring a password for an object on a screen of an electronic device and for unlocking the password-configured objects selectively with object-specific passwords.

In accordance with an aspect of the present invention, a method for controlling an object of an electronic device is provided. The object control method includes displaying a screen having a plurality of objects, detecting a user gesture for controlling password configuration on the screen, displaying, when an one of the plurality of objects is selected, a password input window, and configuring information input through the password input window as the password of the one of the plurality of objects.

In accordance with another aspect of the present invention, an apparatus for controlling an object control is provided. The apparatus includes a touchscreen which displays a screen having a plurality of objects and detects a user gesture for controlling password configuration on the screen and a control unit which controls the touchscreen to display the screen having the plural objects, detects a user gesture for controlling password configuration on the screen, controls, when one of the plurality of objects is selected on the screen, to display a password input window, and configures information input through the password input window as the password of the one of the plurality of objects.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram illustrating a configuration of an electronic device, according to an embodiment of the present invention;

FIG. 2 is a flowchart illustrating a method of detecting a user gesture for configuring a password for protecting an object and for unlocking a password-configured object, according to an embodiment of the present invention;

FIGS. 3A and 3B are diagrams of screen displays illustrating a method for controlling password configuration of an object, according to an embodiment of the present invention;

FIG. 4 is a flowchart illustrating a method of configuring a password for protecting an object of an electronic device, according to an embodiment of the present invention;

FIGS. 5A to 5F are diagrams of screen displays illustrating a password configuration and unlock method, according to an embodiment of the present invention; and

FIGS. 6A to 6C are diagrams of screen displays illustrating a method of executing a password-configured object, according to an embodiment of the present invention.

### DETAILED DESCRIPTION OF EMBODIMENTS OF THE PRESENT INVENTION

Embodiments of the present invention and the various features and advantageous details thereof are described more fully with reference to the non-limiting embodiments that are illustrated in the accompanying drawings and detailed in the following description. The same reference numbers are used throughout the drawings to refer to the same or like parts. Detailed description of well-known functions and structures incorporated herein is omitted to avoid obscuring the subject matter of the present invention.

The specification and drawings are to be regarded in an illustrative, rather than a restrictive, sense in order to help understand the present invention. It is obvious to those skilled in the art that various modifications and changes can be made thereto without departing from the broader spirit and scope of the invention. Accordingly, the examples provided herein should not be construed as limiting the scope of the present invention.

In the embodiments of the present invention described herein, the term ‘object’ denotes a component (e.g., a button, icon, folder, list item, menu item, and tab of tab bar or toolbar) forming a screen of a display unit. The electronic device is capable of presenting a new screen or change in the current screen in response to the selection of an object which is made by a touch on the screen. For example, the electronic device may show the action of making a call in response to the selection of a call button of a telephony application, selecting a certain item from a list of a configuration application, entering a favorite list in response to the selection of a favorite tab of an Internet browser application, and opening a folder in response to the selection of a folder item of the menu. That is, to perform such functions, an object (e.g., the call button, the configuration list, the favorite tab) is first pressed and released.

In embodiments of the present invention, the terms ‘password configuration mode screen’ denotes the screen presenting color, brightness, glowing, pattern, inversion, shade, and other options for use in configuring the objects that can be protected with a password, so that they are displayed distinctively on the screen when the ‘password configuration’ menu item is selected (i.e. ‘password configuration’ item is selected in a popup menus window).

In embodiments of the present invention, the term ‘boundary’ denotes the boundary between a bezel area and a touch panel area of the electronic device. The touch panel area is an area for detecting a user input and generating a signal for execution of a corresponding function. In embodiments of the present invention, a gesture crossing the boundary (i.e. the boundary between the bezel and touch panel) triggers displaying a popup menu window.

In the following description, the electronic device is any of mobile communication terminal, a smartphone, a tablet, a Personal Computer (PC), a handheld PC, a Portable Multimedia Player (PMP), a Personal Digital Assistant (PDA), and a laptop PC.

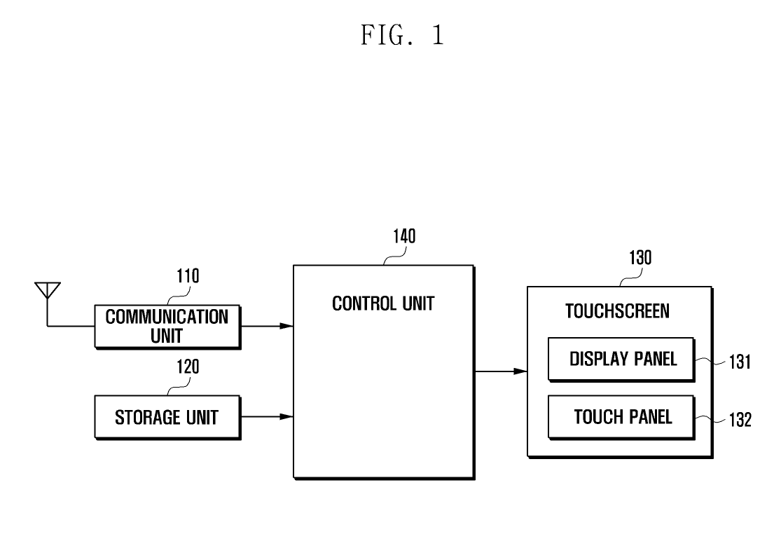

FIG. 1 is a block diagram illustrating a configuration of an electronic device, according to an embodiment of the present invention.

Referring to FIG. 1, the electronic device includes a communication unit 110, a storage unit 120, a touchscreen 130, and a control unit 140.

The communication unit 110 is responsible for processing a voice call, a video call, and data communication with an outside device through a network. The communication unit 110 may include a Radio Frequency (RF) transmitter for up-converting and amplifying the transmission signal and an RF receiver for low noise amplifying and down converting the received signal. The communication unit 110 may include a modulator and a demodulator. The modulator and demodulator processes the signals of various communication technologies including Code Division Multiple Access (CDMA), Wideband CDMA (WCDMA), Long Term Evolution (LTE), Wi-Fi, Wireless Broadband (WiBro), Bluetooth, and Near Field Communication (NFC). The communication unit 110 may include at least one of a cellular communication module, an internet protocol communication module, and a short range communication module.

The storage unit 120 may include a program memory for storing an Operating System (OS) and application programs, and a data memory for storing data generated by the application programs.

In an embodiment of the present invention, the storage unit 120 stores the passwords configured under the control of the control unit 140, and the control unit 140 checks whether the password input for execution of the object or for unlocking the protected object matches the password stored in the storage unit 120.

The touchscreen 130 is formed by integrating a display panel 131 and a touch panel 132. The display panel 131 displays various screens in association with the operation of the electronic device under the control of the control unit 140. The display panel 131 may be implemented with one of a Liquid Crystal Display (LCD), an Organic Light Emitting Diode (OLED) display, and an Active Matrix OLED (AMOLED) display. The touch panel 132 may consist of a hand touch panel for detecting a hand gesture and a pen touch panel for detecting a pen gesture.

In an embodiment of the present invention, the touch panel 132 can detect a user gesture crossing the boundary (i.e. the boundary between the bezel and touch panel) under the control of the control unit 140. In detail, the touch panel 132 can detect a drag gesture from the bezel to the touch panel 132 under the control of the control unit 140. The touch panel 132 also can detect a gesture configured by the user (e.g. a double tap and a multi-touch) under the control of the control unit 140. The display panel 131 displays a popup menu window in response to the detection of the user gesture. The display panel 131 displays a password-protectable object with graphic effects, such as a glow, pattern, shade, inversion, etc. under the control of the control unit 140. The display unit 131 displays a password input window to receive a password for configuring or unlocking the password protection of an object under the control of the control unit 140.

The control unit 140 controls overall operations of the electronic device, signal flows among internal component of the electronic device, data processing, and battery power supply to the components of the electronic device.

In an embodiment of the present invention, if the touch panel 132 detects a user gesture on a screen displaying object, the control unit 140 displays a popup menu window by means of the display panel 131. If a user gesture for selecting the ‘password configuration’ item within the popup menu window is detected by the touch panel 132, the control unit 140 controls such that password-configurable objects are processed graphically (e.g. with glow, pattern, shade effects) so as to be distinct from password-configured objects. If the detected user gesture is a touch gesture made to a password-configurable object, the control unit 140 performs a password configuration operation. If the touch gesture is made to a password-configured object, the control unit 140 performs a password unlock operation.

If a touch gesture to an object is detected on a screen displaying a plurality of objects, the control unit 140 determines whether the object is password-configured or not. The object has a unique identifier (ID) value for use in the entire platform. The ID mapped to the object is allocated identically even when the application is re-executed or the device is rebooted. For example, if an ID ABC123 is allocated to the object A, the ID ABC123 is used for object A even when the device is rebooted. The control unit 140 may aggregate the objects to which no unique ID in the entire platform can be allocated and apply one password to all of the objects to which no unique ID can be allocated. The password which the user allocates to an object is stored in a secure database (DB). The object ID is stored in the DB along with the password. Even when the electronic device is rebooted, the password configured for use with the ID of the object can be reused. It is possible to maintain the same ID for the object because the unique ID of the object is derived from the code of generating the object. Although, the unique ID can be generated in various ways, it is typical to generate the ID in such that the name of the object, as designated by the developer, is concatenated with the ID of the object. For example, if the object name is ‘com.samsung.app’ and if an ID of ‘btn1’ is assigned to the object, the ID of the object becomes ‘com.Samsung.app.btn1’. If the user sets a password of ‘abcd’ for the object, the object ID ‘com.samsung.app.btn1’ is stored with the password ‘abed’ in the secure DB.

If the application is deleted, all of the passwords associated with the application are deleted. This means that the control unit 140 is capable of determining whether an object is a password-configured object based on the object ID. If it is determined that the object is a password-configured object, the control unit 140 performs a password unlock operation, otherwise if the object is not a password-configured object, the control unit 140 executes the selected object.

Although the electronic device may further include other supplementary components, such as a Global Positioning System (GPS) module for receiving location information signal, and an audio processing unit having a microphone and a speaker, a camera module for taking still and motion picture of a subject, and a hard key-based input unit for receiving user input, detailed drawings and descriptions thereon are omitted herein.

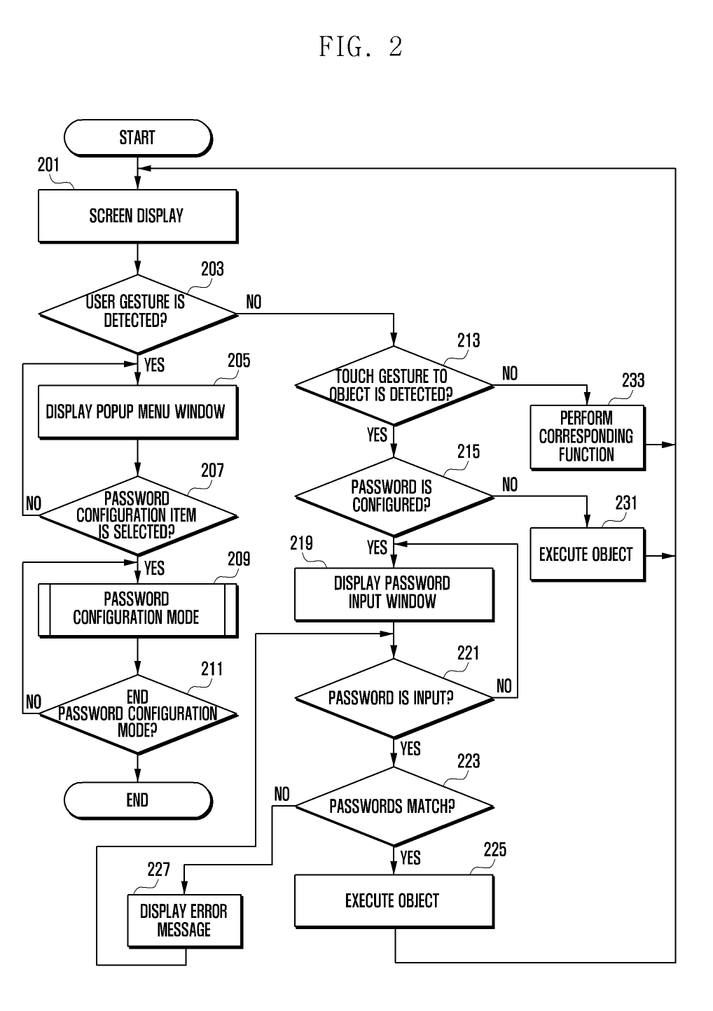

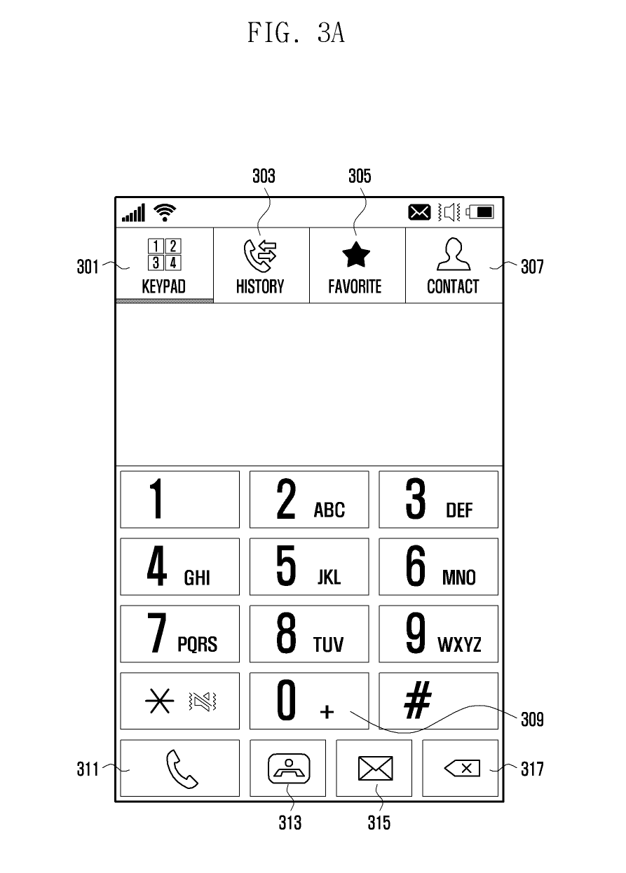

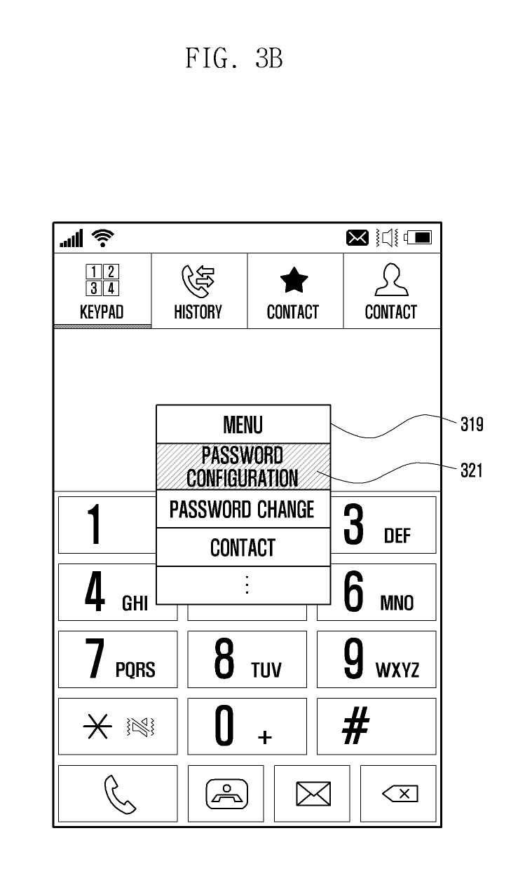

FIG. 2 is a flowchart illustrating a method of detecting a user gesture for configuring a password for protecting an object and for unlocking a password-configured object, according to an embodiment of the present invention. FIGS. 3A and 3B are diagrams of screen displays illustrating a method for controlling password configuration of an object, according to an embodiment of the present invention.

Referring to FIGS. 2 and 3A and 3B, the control unit 140 controls such that the display panel 131 displays a screen having the objects displayed thereon, at step 201. The objects may include buttons, icons, folders, menu items, and tabs of a tab bar and a toolbar.

In an embodiment of the present invention, the description is directed to a telephony application execution screen having plural objects, as shown in FIG. 3A. The telephony application execution screen includes a tab bar made up of tab objects 301, 303, 305, and 307, and a keypad made up of key objects 309, 311, 313, 315, and 317.

The control unit 140 determines whether a user gesture is detected on a screen displaying objects at step 203. The user gesture may be a user input for configuring a password to an object displayed on the screen or may be a user input for displaying a popup menu window to enter a menu item (e.g. ‘password configuration’ item) for unlocking the password. The description is made under the assumption that the user gesture is a drag made from the bezel to the touch panel 132 or from the touch panel 132 to the bezel. However, the user gesture is not limited thereto and may be embodied in any type of gesture configured by the user (e.g. double tab and multi-touch). The control unit 140 can detect the user gesture by means of the touch panel 132. If the user gesture is detected, the control unit 140 controls the display panel 131 to display the popup menu window to enable the user to set a password for an object or unlock an object having a password.

In detail, if a user gesture is made on a screen displaying objects, the control unit 140 detects the user gesture at step 203 and controls such that the display panel 131 displays the popup menu window 319, as shown in FIG. 3B, at step 205. The popup menu window 319 includes ‘password configuration,’ password change,' and ‘contact’ items. The control unit 140 determines whether an input of selecting the ‘password configuration’ item 321 is detected in the popup menu window 319, at step 207. If an input for selecting the ‘password configuration’ item 321 is detected, at step 207, the control unit 140 controls to enter the password configuration mode at step 209. In the password configuration mode, the control unit 140 controls such that the password-configured objects and non-password-configurable objects are graphically distinguished from each other. If a user gesture is made to a password-configured object, the control unit 140 executes a password unlock operation. Otherwise if the user gesture is made to the non-password-configurable object, a password configuration operation is executed.

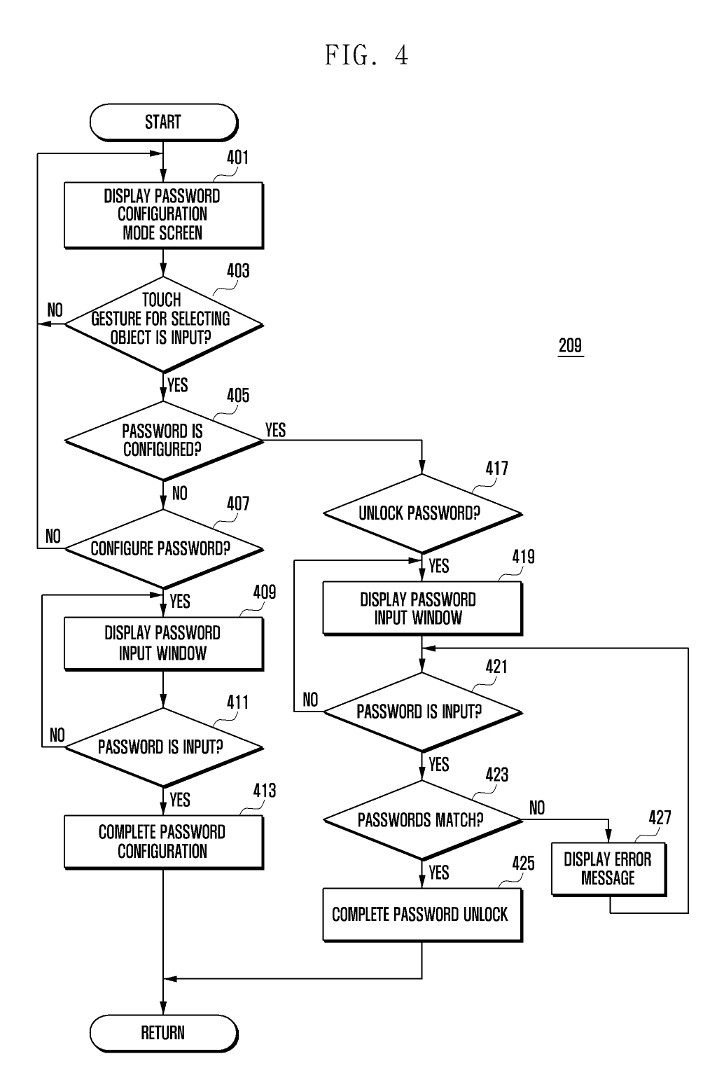

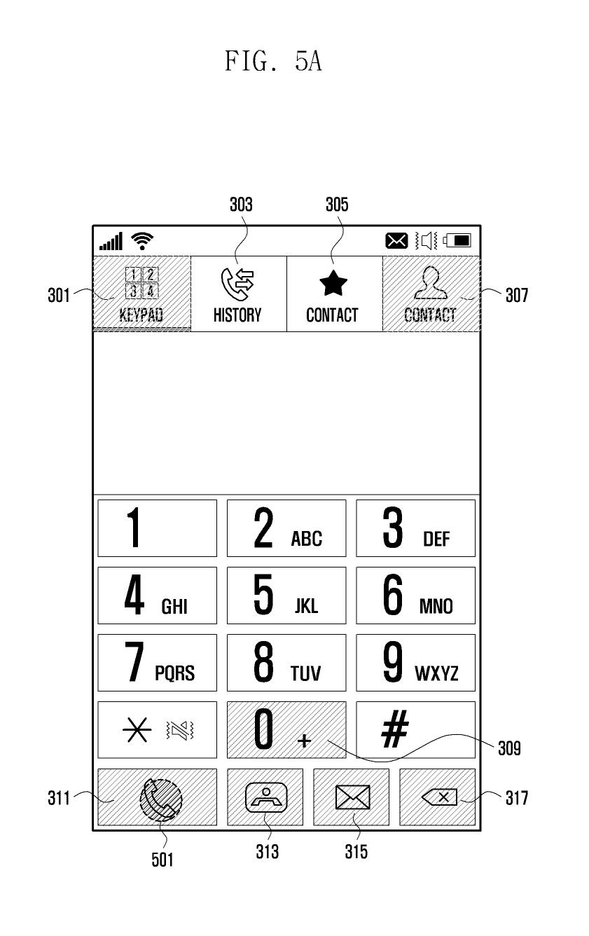

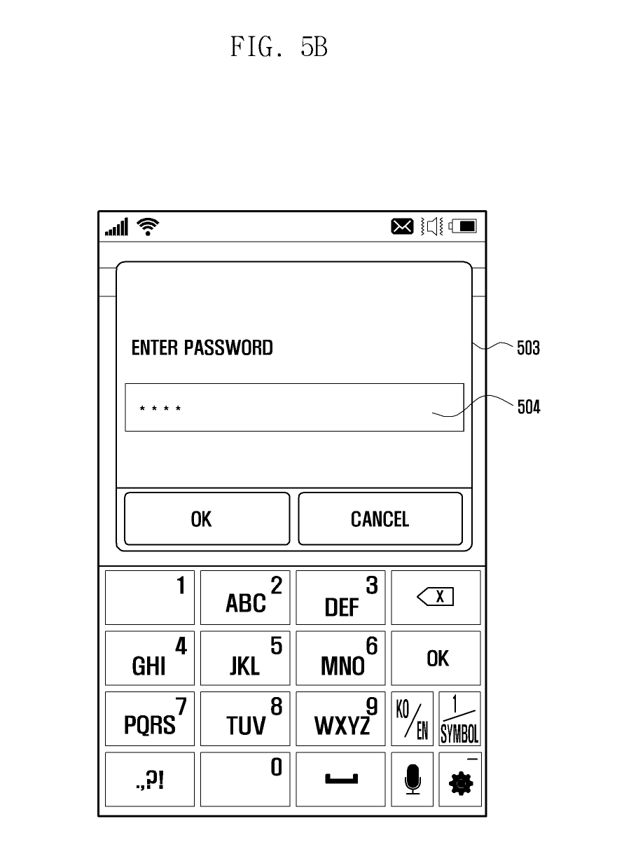

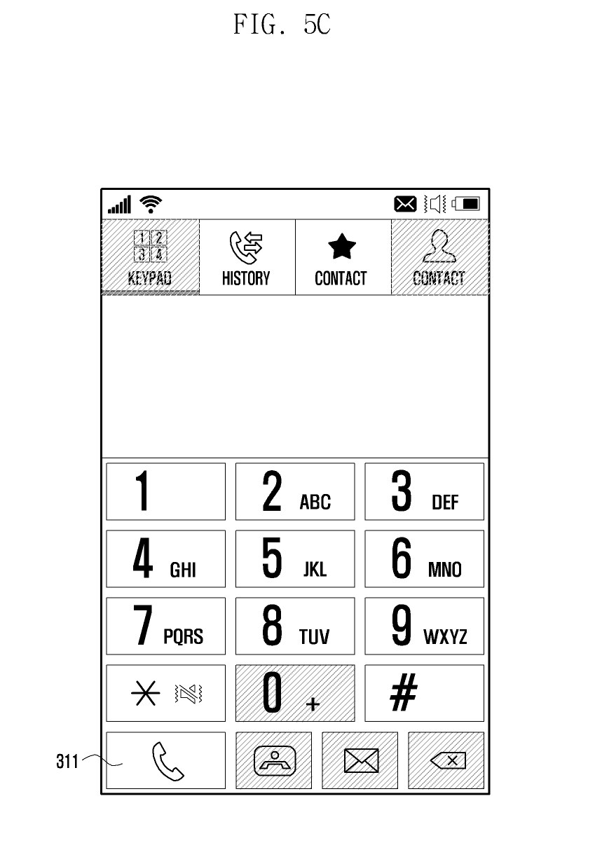

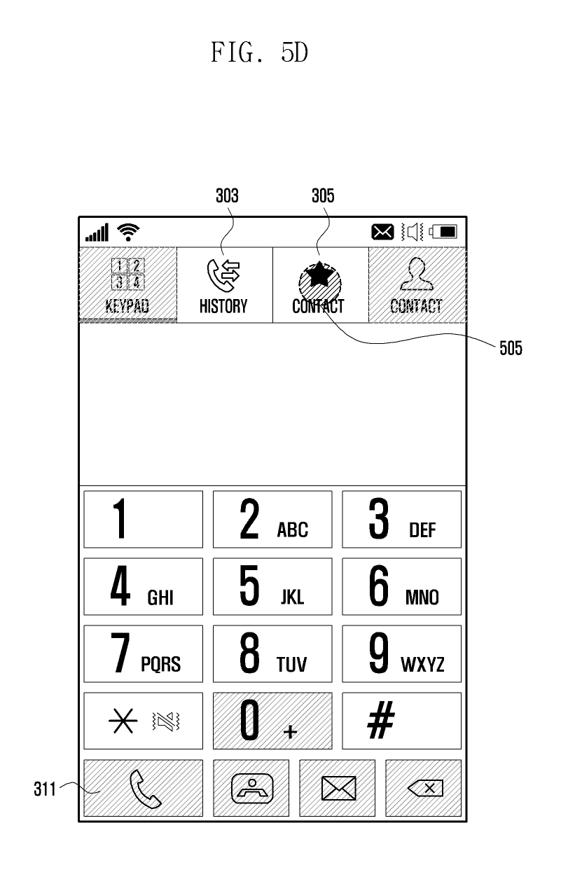

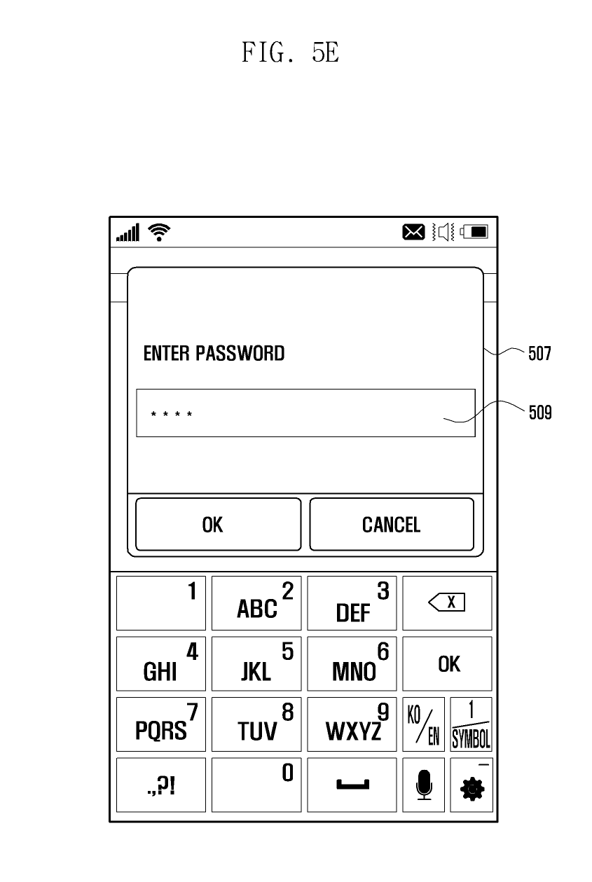

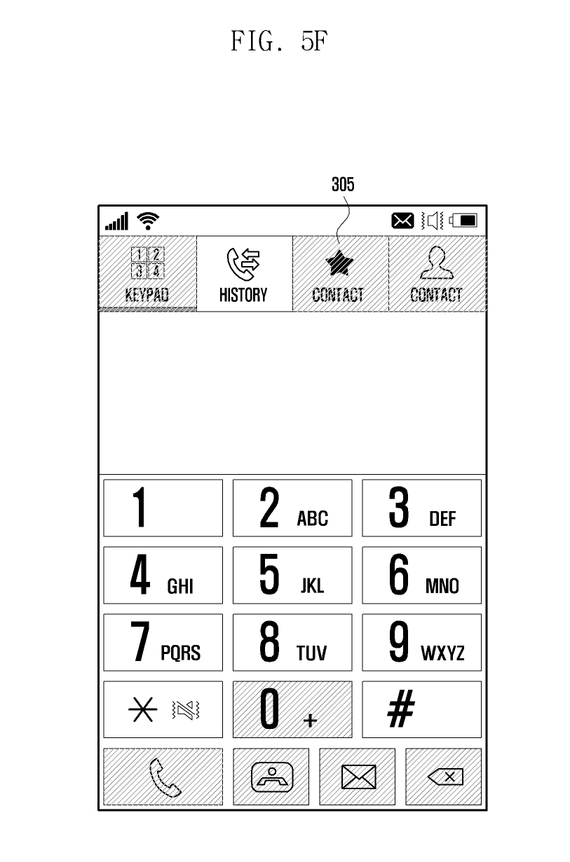

A detailed description of step 209 of FIG. 2 is made with reference to FIGS. 4 and 5A to 5F.

FIG. 4 is a flowchart illustrating a method of configuring a password for protecting an object of an electronic device, according to an embodiment of the present invention. FIGS. 5A to 5F are diagrams of screen displays illustrating a password configuration and unlock method, according to an embodiment of the present invention.

Referring to FIGS. 4 and 5A to 5F, the control unit 140 controls the display panel 131 to display the password configuration mode screen at step 401 in response to the input for selecting the ‘password configuration’ item which is detected at step 207 of FIG. 2. The password configuration mode screen displays the password-configurable objects processed graphically with glow, pattern, shade, and inversion effects so as to be distinguished from the password-configured objects. Here, the description is made under the assumption that the password-configurable objects are processed graphically to have a pattern so as to be distinguished from the password-configured objects. In the telephony application execution screen of FIG. 5A, the password-configurable objects 301, 307, 309, 311, 313, 315, and 317 are processed graphically to have a pattern. Meanwhile, the password-configured objects 303 and 305 have no graphic effect.

The control unit 140 determines whether a touch gesture for selecting an object is detected on the password configuration mode screen by means of the touch panel 132 at step 403. If a touch gesture for selecting an object is detected at step 403, the control unit 140 analyzes the position where the touch gestured is detected to determine whether the corresponding object is set with a password at step 405. If the touch gesture is made to one of the objects which is not set with a password, i.e., the password-configurable objects 301, 305, 309, 311, 313, 315, and 317, the control unit 140 executes the password configuration operation.

In detail, if the touch gesture is made to the password-configurable object 311 of FIG. 5A, as denoted by reference number 501, the control unit 140 determines whether to configure a password for the object at step 407 and, if it is determined to configure a password for the object, the control unit 140 controls the display panel 140 to display a password input window 503 of FIG. 5B at step 409. Although the description is made under the assumption that the password configuration is made with the user input of a security number, the password input may be substituted by a pattern gesture or fingerprint recognition.

Next, the control unit 140 determines whether a password is input through the password input window 503 at step 411. If a password is input as denoted by reference number 504 of FIG. 5B, the control unit 140 completes the password configuration operation at step 413. If the password configuration completes at step 413, the control unit 140 controls such that the display panel 131 displays the object 311 as a password-configured objection, without any pattern as shown in FIG. 5C.

If the touch gesture is made to one of the password-configured objects 303, 305, and 311, as shown in FIG. 5D, the control unit 140 executes the password unlock operation on the object.

In detail, if the touch gesture is made to a password-configured object 305 as denoted by reference number 505 in FIG. 5D, the control unit 140 determines whether to unlock the password at step 417 and, if it is determined to unlock the password, then at step 419, the control unit 140 controls the display panel 131 to display the password input window 507, as shown in FIG. 5E. The control unit 140 determines whether a password is input through the password input window 507 at step 421. The password unlock can be performed in the same method as the password configuration (e.g. password, pattern gesture, and fingerprint recognition). Since the password configuration is performed by inputting a security number as the password, the password can be unlocked by inputting a matching security number. That is, if the password is input, as denoted by reference number 509 of FIG. 5E, the control unit 140 detects this at step 421 and determines whether the entered password matches the preset password at step 423. If the entered password matches the preset password, the control unit 140 unlocks the password at step 425. If the password is unlocked at step 425, the control unit 140 processes the corresponding object graphically as denoted by reference number 305 of FIG. 5F to notify that the object is password-configurable.

If it is determined that the entered password does not match the preset password at step 423, the control unit 140 controls the display panel 131 to display an error message at step 427. Although the description is made under the assumption that an error message is presented for password mismatch in various embodiments of the present invention, the present invention is not limited thereto but can be embodied by giving a penalty of restricting password input during a predetermined period.

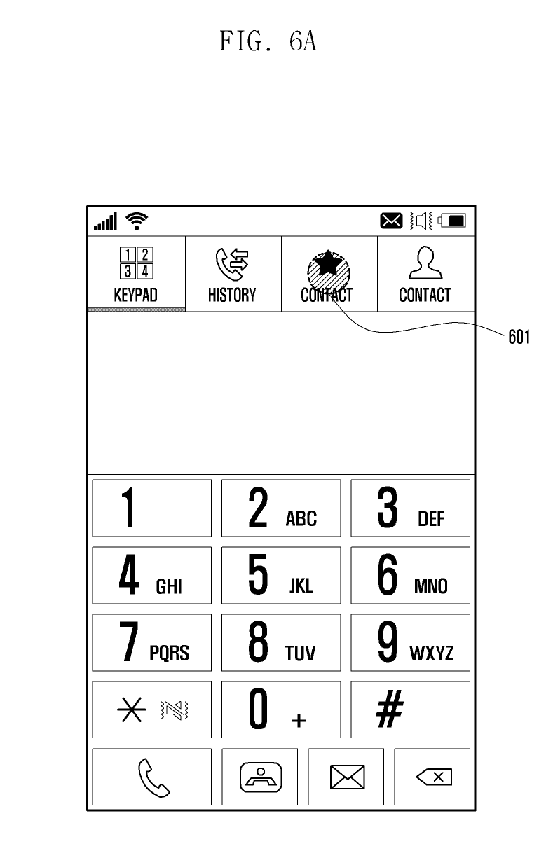

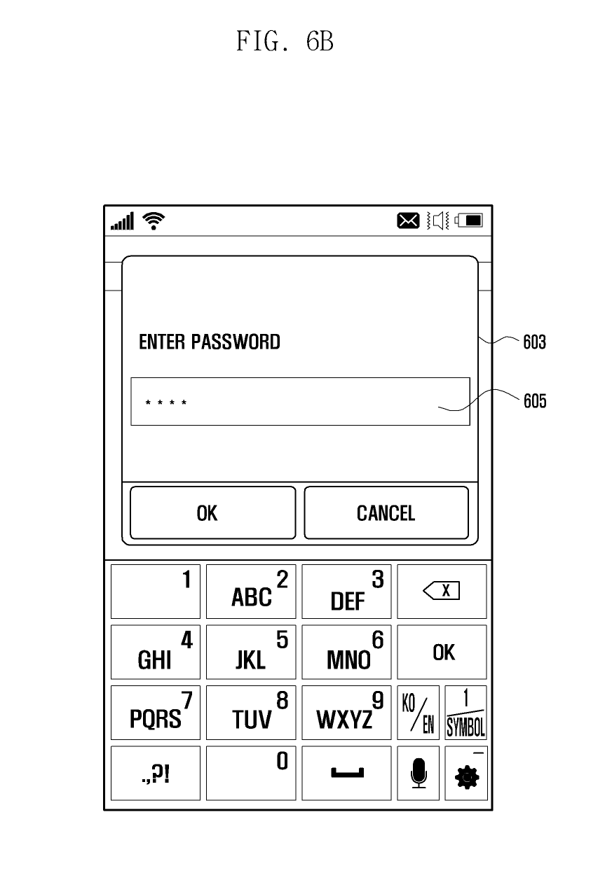

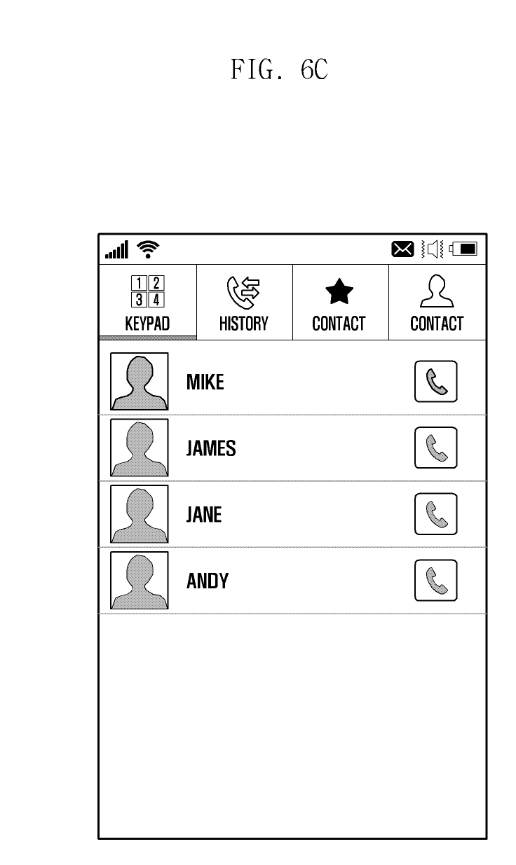

Returning to FIG. 2, if, at step 203, no user gesture is detected on the screen displaying object, the control unit 140 determines whether a touch gesture is made to an object through the touch panel 132 at step 213. The touch gesture refers to a user input for executing an object displayed on the screen of the display panel 131. If the touch gesture is not made to select an object displayed on the screen, then at step 233, the control unit 140 performs the corresponding function. If the touch gesture is made to select the object, the control unit 140 determines, at step 215, whether the selected object is a password-configured object or an object which is not password-configured. If the selected object is a password-configured object, the control unit 140 executes the object after unlocking the password, as described more fully with reference to FIGS. 6A-6B. At this time, the password is unlocked temporarily and the object is locked back with the preset password e.g., when execution of the object is terminated. Otherwise, if at step 215, the selected object is determined not to be password-configured, the control unit 140 executes the object immediately.

FIGS. 6A to 6C are diagrams of screen displays illustrating a method of executing a password-configured object configured with a password, according to an embodiment of the present invention.

Referring to FIGS. 2 and 6A to 6C, if a touch gesture is made to the object 305, as denoted by reference number 601 of FIG. 6A, the control unit 140 determines whether a password is configured for the object selected by the touch gesture (i.e. whether the object is a password-configured object or not a password-configured object) at step 215. If the selected object is a password-configured object, the control unit 140 controls the display panel 131 to display the password input window 603, as shown in FIG. 6B, at step 219. At this time, the object password unlock can be performed using the same method as the password configuration (e.g. password, pattern gesture, and fingerprint recognition). Since the password configuration is performed by inputting a security number as the password in various embodiments of the present invention, the password can be unlocked temporarily by inputting a matching security number.

The control unit 140 determines whether the password is entered through the password input window 603 at step 221. If the password is input, the control unit 140 determines whether the entered password matches the preset password at step 223. If the passwords match, the control unit 140 executes the object at step 225. Next, the control unit 140 controls the display panel 131 to display the object execution screen as shown in FIG. 6C.

If it is determined that the entered password does not match the preset password at step 223, the control unit 140 controls the display panel 131 to display an error message at step 227. Although the description is made under the assumption that an error message is presented for password mismatch in various embodiments of the present invention, the present invention is not limited thereto but can be embodied by giving a penalty of restricting password input during a predetermined period.

If it is determined that the selected object is a non-password-configured object at step 215, the control unit 140 executes the selected object immediately at step 231. For example, if the touch gesture is made to the non-password-configured object 305, as denoted by reference number 601 of FIG. 6A, the control unit 140 controls the display panel 131 to display the object execution screen as shown in FIG. 6C.

As described above, the object control method and apparatus of the present invention is advantageous in that the user can set a password for individual objects displayed on the screen of an electronic device. Also, the object control method and apparatus of the present invention is advantageous in terms of allowing for the unlocking of objects with object-specific passwords, such that only the authenticated user can check the object result.

Although the object control method and apparatus of the invention have been described using specific terms, the specification and drawings are to be regarded in an illustrative rather than a restrictive sense in order to help understand the present invention. It will be obvious to those skilled in the art that various modifications and changes can be made thereto without departing from the broader spirit and scope of the invention.

What is claimed is:

1. A method for controlling an object of an electronic device, the method comprising:
displaying a screen having a plurality of objects;
detecting a user gesture for controlling password configuration on the screen;
displaying, when one of the plurality of objects is selected, a password input window; and
configuring information input through the password input window as the password of the one of the plurality of objects.

2. The method of claim 1, wherein displaying the screen comprises:
determining whether an object is selected;
displaying, when the selected object is protected with a password, the password input window;
executing, when an input password matches a preset password, a function of the selected object; and
displaying, when the input password does not match the preset password, an error message.

3. The method of claim 2, wherein configuring information input through the password input window as the password of the one of the plurality of objects comprises displaying a message notifying that the one of the plurality of objects is password-configured.

4. The method of claim 2, wherein the selected object includes at least one of button, icon, folder, list item, menu item, and tab.

5. The method of claim 4, wherein the user gesture comprises at least one of a drag from a bezel to a touch panel of the electronic device, a drag from the touch panel to the bezel, and a gesture preset by a user.

6. The method of claim 5, wherein detecting the user gesture comprises:
displaying a popup menu window upon detecting the user gesture; and
detecting an input for selecting a password configuration item in the popup menu window.

7. The method of claim 6, wherein detecting an input for selecting a password configuration item comprises:
displaying, when the password configuration item is selected, password-configurable objects on the screen;
displaying, when one of the password-configurable objects is selected, a password input window; and
configuring, when a password is entered in the password input window, the password to the one of the password-configurable objects.

8. The method of claim 7, wherein the password is one of a security number, a specific pattern gesture, and a fingerprint.

9. The method of claim 7, further comprising:
displaying, when a password-configured object is selected, the password input window;
determining, when the password is input through the password input window, whether the input password matches the preset password; and
unlocking, when the passwords match, the password-configured object.

10. An apparatus for controlling an object, the apparatus comprising:
a touchscreen which displays a screen having a plurality of objects and detects a user gesture for controlling password configuration on the screen; and
a control unit configured to
control the touchscreen to display the screen having the plural objects,
detect a user gesture for controlling password configuration on the screen,
when one of the plurality of objects is selected on the screen, display a password input window, and
configure information input through the password input window as the password of the one of the plurality of objects.

11. The apparatus of claim 10, wherein the control unit is further configured to
determine whether an object is selected,
control, when the selected object is protected with a password, the touchscreen to display the password input window,
execute, when an input password matches a preset password, a function of the selected object, and
control, when the input password does not match the preset password, the touchscreen to display an error message.

12. The apparatus of claim 11, wherein the control unit is further configured to control the touchscreen to display a message notifying that the one of the plurality of objects is password-configured by the password.

13. The apparatus of claim 11, wherein the selected object includes at least one of button, icon, folder, list item, menu item, and tab.

14. The apparatus of claim 13, wherein the user gesture comprises at least one of a drag from a bezel to a touch panel of the electronic device, a drag from the touch panel to the bezel, and a gesture preset by a user.

15. The apparatus of claim 14, wherein the control unit is further configured to control the touchscreen to display a popup menu window upon detecting the user gesture and detect an input for selecting a password configuration item in the popup menu window.

16. The apparatus of claim 15, wherein the control unit is further configured to
control, when the password configuration item is selected, the touch screen to display password-configurable objects on the screen,
control, when one of the password-configurable objects is selected, the touchscreen to display a password input window, and
configure, when a password is entered in the password input window, the password to the one of the password-configurable objects.

17. The apparatus of claim 16, wherein the password is one of a security number, a specific pattern gesture, and a fingerprint.

18. The apparatus of claim 17, wherein the control unit is further configured to
control, when a password-configured object is selected, the touchscreen to display the password input window,
determine, when the password is input through the password input window, whether the input password matches the preset password, and
unlock, when the passwords match, the password-configured object.
